(19) United States
(12) Patent Application Publication
(10) Pub. No.: US 2005/0234724 A1
(43) Pub. Date: Oct. 20, 2005

(54) System and method for improving text-to-speech software intelligibility through the detection of uncommon words and phrases

(76) Inventors: Andrew Aaron, Ardsley, NY (US); Ellen Eide, Bedford Hills, NY (US)

Correspondence Address: DILWORTH & BARRESE, LLP, 333 EARLE OVINGTON BLVD., UNIONDALE, NY, 11553, US

(21) Appl. No.: 10/825,578

(22) Filed: Apr. 15, 2004

(51) Int. Cl. G10L 13/08

(52) U.S. Cl. 704/260

(57) ABSTRACT

Disclosed is a system and method for improving the intelligibility of speech output by a speech synthesizer by determining if uncommon words exist in the text, and if it is determined that an uncommon word exists in the text, pausing the output of the synthesized speech of the uncommon word to offset the uncommon word from its surrounding speech.

### FIELD OF THE INVENTION

The present invention relates to a system and method for improving text-to-speech software intelligibility by detecting uncommon words and phrases.

### BACKGROUND OF THE INVENTION

Text-to-speech (“TTS”) software has made vast improvements in the previous few years. What used to be a serviceable but robotic-sounding system now mimics the human voice with great fidelity. But paradoxically, the increased fidelity leads to an increase in perception faults. As the electronically produced sound approaches that of a live human voice, all of the shortcomings of a human voice are also incorporated into the reproduced sounds.

FIG. 1 is a diagram of a typical text-to-speech system. Shown in FIG. 1 is input text 102. The input text 102 can be from any number of sources and in a variety of textual formats. Text normalization module 103 receives the input text 102 and processes the text into a format that the system can readily convert to synthesized speech. These processes can include organizing input sentences into manageable lists of words, identifying numbers, abbreviations, etc. . . . Also, contextual analyses can be performed in the text normalization module 103 to determine additional information relating to the words based on their use in the sentence, to be used during the speech conversion. The normalized text 104 output from the text normalization module 103 is forwarded to a text-to-unit sequence conversion module 105 and a prosody prediction module 108. The text-to-unit sequence conversion module 105 analyzes each word to determine its word root base. For example, if the word “economically” were input into the text-to-unit sequence conversion module 105, the module would determine that the baseform of “economically” is “economic”. In the text-to-unit sequence conversion module 105, the normalized text is converted to a sequence of units that define the pronunciations and form the targets in future segment selection and concatenation. The output unit sequence targets 106 and 107 of the text-to-unit sequence conversion module 105 are forwarded to the prosody prediction module 108 and a segment selection and concatenation module 110. The prosodic prediction module 108 analyzes the normalized text 104 to determine properties of speech that relate to pitch, loudness, syllable length, etc. . . . This analysis incorporates the unit sequence targets 107 generated by the text-to-unit sequence conversion module 105. The properties of speech are also used to further enhance the final output speech to sound more like human speech. The prosody prediction module 108 outputs prosodic targets 109. The prosodic targets are points were variations in the pitch, loudness, syllable length, etc., are flagged to occur. Along with the unit sequence targets 106, the prosodic targets 109 are also input into the segment selection and concatenation module 110.

A segment database 111 stores information relating to how certain words are commonly grouped together and speech properties related to those groupings. The information stored in the segment database 111 includes phonetic rules used to group words. The segment database 111 also acts as a temporary storage database for the segment selection process performed in the segment selection and concatenation module 110. These stored groupings reduce the analysis time and complexity by eliminating the need to reanalyze common word groupings. The segment database 111 receives input from and outputs to the segment selection and concatenation module 110. The segment selection and concatenation module 111 performs two major functions, that is, which word groupings are to be used and concatenating the word groupings. The segments are selected to reduce concatenation problems that lead to phonetic distortions in the finalized output speech. The segments are selected based on the various phonetic rules stored in the segment database 111. After the segments have been selected, the concatenation process occurs to link up the selected segments. The final output of the segment selection and concatenation module 110 is synthetic speech 112 that incorporates the previous word and phrase analysis of the system. The synthetic speech 112 is subjected to a final prosodic modification in the prosodic modification module 113. A final synthetic speech output 114 is generated.

### SUMMARY OF THE INVENTION

One of the main shortcomings of electronically produced speech is its lack of ability to hold the attention of a listener for long passages. While TTS is widely used to play back news stories and read back long emails, its limited prosodic richness and monotonous tone present a barrier. When listening to a long passage, there are sections of great clarity, clouded with sections punctuated by occasional words or word groups that are harder to understand, or that suffer from bumpy synthesis. These junctures present an increased cognitive load, and the listener must work harder to decipher what he has just heard. Meanwhile, the TTS marches on. So while the listener is trying to determine a previous word, the software is busy producing new ones. The end result is listener fatigue. The listener feels as though the TTS is being insensitive to the needs of the listener, whose mind ultimately begins to wander. There are no current solutions to this problem.

An object of the present invention is to substantially solve at least the above problems and/or disadvantages and to provide at least the advantages below. Accordingly, an object of the present invention is to provide a system and method for improving text-to-speech software intelligibility by detecting uncommon words and sequences.

Another object of the present invention is to provide a method for improving the intelligibility of speech output by a speech synthesizer, comprising the steps of determining if uncommon words exist in the text; and if it is determined that an uncommon word exists in the text, pausing the output of the synthesized speech of the uncommon word to offset the uncommon word from its surrounding speech.

A further object of the present invention is to provide a system for improving the intelligibility of speech output by a speech synthesizer, comprising a rare sequence detector to determining if uncommon words exist in the text, and if it is determined that an uncommon word exists in the text, pausing the output of the synthesized speech of the uncommon word to offset the uncommon word from its surrounding speech.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following:

FIG. 1 is a block diagram illustrating a speech synthesizer according to the prior art systems; and

FIG. 2 is a block diagram illustrating a speech synthesizer according to an embodiment of the present invention.

### DETAILED DESCRIPTION OF THE PREFERRED EMBODIMENT

Several preferred embodiments of the present invention will now be described in detail herein below with reference to the annexed drawings. In the drawings, the same or similar elements are denoted by the same reference numerals even though they are depicted in different drawings. In the following description, a detailed description of known functions and configurations incorporated herein has been omitted for conciseness.

Prior to describing the detailed structure and method of the present invention, an example will be presented illustrating some of the problems associated with synthesizing speech. The following is an example of a sentence from a sample news report: “‘Bank of America tends to be a pretty good litmus test for the financial services sector as a whole,’ said Doug Lister of Wachovia Securities, a financial services company.” The majority of this text will synthesize quite well and sound quite good coming out of the TTS engine. But the system will have problems analyzing the unfamiliar name “Doug Lister”. The TTS engine may produce “Doug Lister” or “Doug Glister” depending on the prosodic and phonetic processing algorithms. Since the listener is probably unfamiliar with the name to begin with, in the listener's mind either is equally likely, and would sound pretty much the same. And while the listener is trying to determine what name was just said, the TTS engine continues to generate further synthesized speech. Eventually the TTS engine processes the word “Wachovia.” At this point, while still attempting to determine the name that was previously output, the listener now must determine what he heard when the TTS engine output its version of “Wachovia”. IN the mind of the listener, the following may occur, “Was that ‘Wockovious Securities’ or ‘Wock Ovia Securities’? No, it was ‘Wachovia Securities’.” Confronted with enough of these incidents, the listener begins to feel as though he is working too hard in his attempt to listen to the synthesized speech, and the listener falls behind, ultimately missing some vital content.

Live news readers can compensate somewhat for this problem by slightly slowing down the output of unfamiliar words and by adding an imperceptible pause before and after a problematic word. The live news readers often sound slightly hesitant. The hesitations result in two effects on the listener. First, it signals the listener to pay extra attention to the output word. Second, it gives the listener some time to catch up. A live news reader would therefore read, “‘Bank of America tends to be a pretty good litmus test for the financial services sector as a whole,’ said--Doug--Lister-of-Wachovia--Securities-, a financial services company.”

While the current TTS systems do not truly understand the content of their speech to the point where a system could be programmed to know what words to emphasize, some of these problems areas are in fact predictable and therefore lend themselves to software solutions.

As stated earlier, one of the objectives of the present invention is to determine in advance which words or phrase are likely to suffer from uneven synthesis and then adjust the synthetic speech output accordingly. There are several metrics that can be employed in the detection process. For example, the TTS system according to the present invention includes a dictionary that can be used to determine words that are not contained therein. The TTS system can also recognize capitalization rules. Therefore, the system can with some reliability detect uncommon words or unfamiliar proper names, which have a high likelihood of synthesis problems. When an unrecognized word is detected, a pause can be added during its output, and/or the word can be synthesized with longer durations.

The present invention can also use a statistical language model, which is a statistical representation of language as it is commonly used. To construct such a model, a large amount of text is analyzed and a mechanism for assigning a probability to any sequence of words is generated. This model can be used to detect low-probability words and word sequences. For example “New York” is a commonly occurring sequence of words and should receive a relatively high probability score from our statistical language model as compared to “New Braunfels.” Words or word sequences that receive a low probability score would be treated with pauses and/or longer durations.

Another method for identifying potentially difficult words is to use the internal assessment mechanism of the synthesizer. The contents of the segment database (box 111) are searched according to the unit sequence and prosodic targets. How close the selected segments come to the targets is known internally and can be used as the assessment mechanism. If the internal assessment falls below a quality threshold, i.e., the synthesis quality is poor, the same pause and/or duration lengthening can be applied. Although only a few examples of detection concepts are presented herein, several other metrics or algorithms are contemplated as methods of detecting uncommon words or phrases.

Additionally, false positives are that may be adjusted for in the present invention are of no cause for concern. If the occasional well-synthesized word is output at a slower rate, this will not necessarily sound abnormal. The present invention is at least designed to detect a reasonable percentage of rough synthesis and provide the strategic application of pauses and duration control, to greatly increase the overall comprehension by the listener.

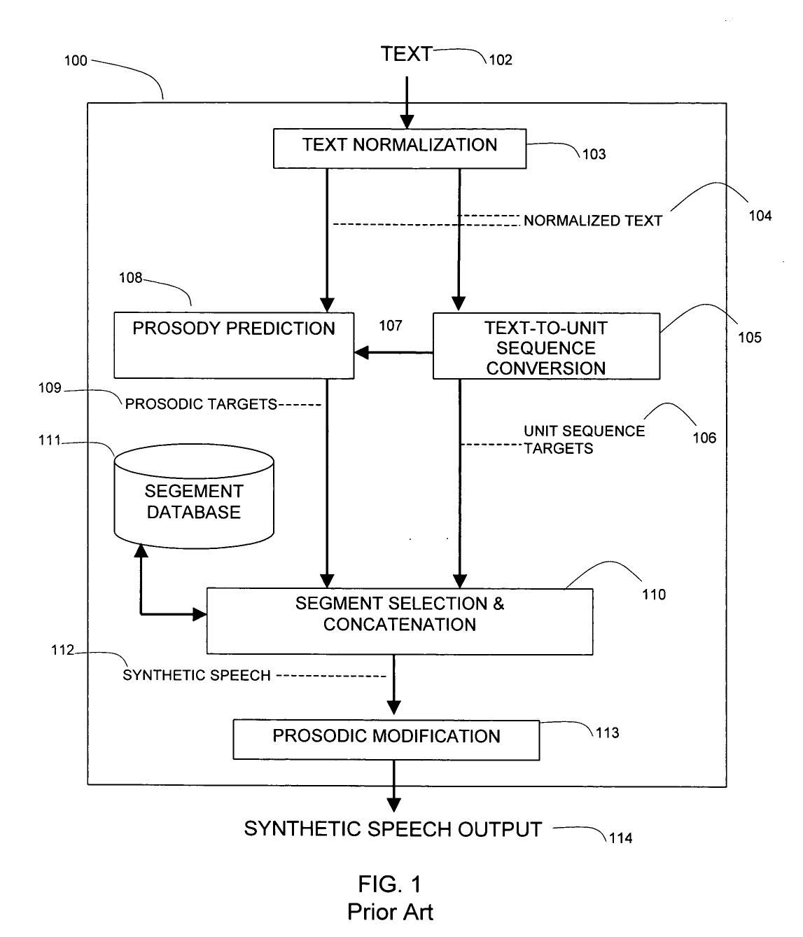

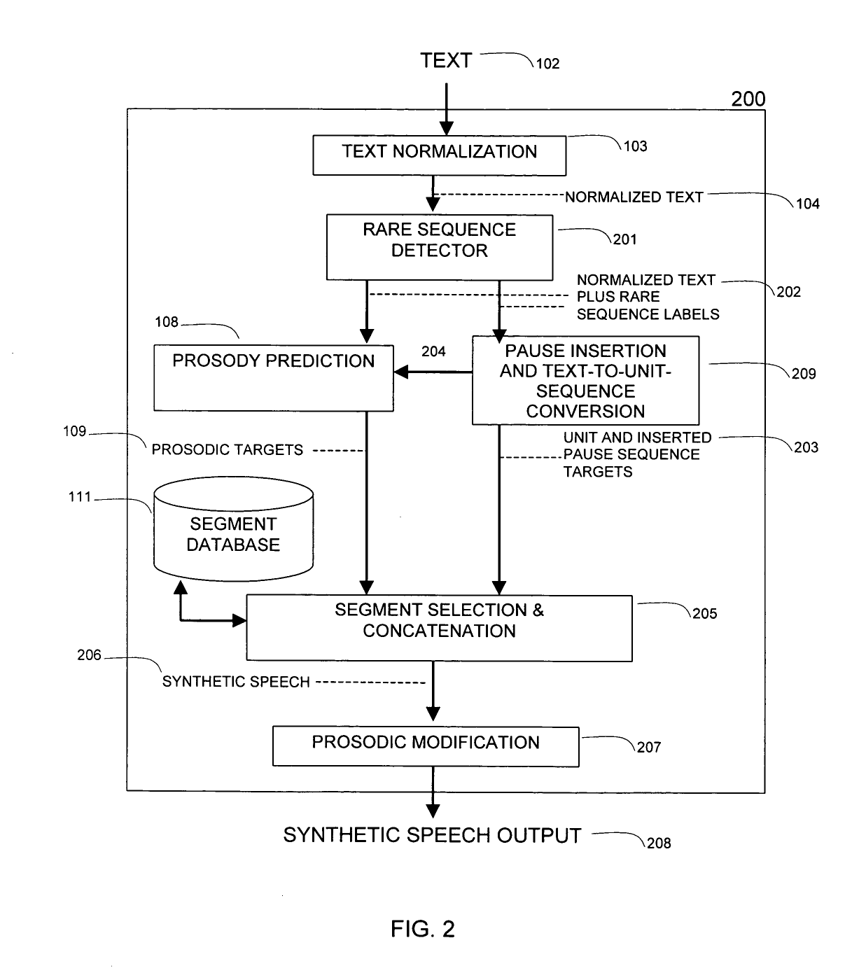

FIG. 2 is a diagram illustrating the TTS engine according to an embodiment of the present invention. The present invention will now be described with reference to FIG. 2. The modules and elements shown in FIG. 2 that bear the same reference labels as the modules and elements of FIG. 1 are similar to those in the prior art systems and generally perform similar functions. Text 102 is input and normalized by text normalization module 103. The normalized text 104 is input into rare sequence detector 201. The rare sequence detector 201 detects uncommon words and sequences based on the above outlined metrics. For example, if a word or phrase is not found in the TTS system dictionary, the word or phrase is marked as rare. Also the rare sequence detector 201 can recognize capitalization rules and if a word is capitalized, it is marked rare, keeping in mind the occasional false markings will only cause a word or phrase to output at a slower rate, which will not affect the overall comprehension of the listener. Additionally, the rare sequence detector 201 can contain a statistical language model trained on large amounts of text to spot low probability words and word sequences that are marked rare. And further, the rare sequence detector 201 can be programmed to predict when a difficult word or word pair has been encountered. Whatever rare word or phrase detection scheme is embodied, the TTS system according to the present invention inserts a rare marking in the normalized text, wherein the system will insert a pause when finalizing the output speech. When the TTS System encounters a section of low confidence or unknown words, it will add pauses and increase durations.

The normalized text plus rare sequence labels 202 output from the rare sequence detector 201 is forwarded to the text-to-unit sequence conversion module 105 and the prosody prediction module 108. The text-to-unit sequence conversion module 105 analyzes each word to determine its word root base as described above. The output unit and inserted pause sequence targets 203 and 204 of the pause insertion and text-to-unit sequence conversion module 209 are forwarded the prosody prediction module 108 and the segment selection and concatenation module 110. The prosodic prediction module 108 analyzes the normalized text 104 to determine properties of speech that relate to pitch, loudness, syllable length, etc. . . . The prosody prediction module 108 outputs the prosodic targets 109. The segment database 111 stores information relating to how certain words are commonly grouped together and speech properties related to those groupings. The segment selection and concatenation module 111 performs the word groupings and concatenation of the word groupings. After the segments have been selected, the concatenation process occurs to link up the selected segments. The final output of the segment selection and concatenation module 205 is synthetic speech 206 that incorporates the previous word and phrase analysis of the system, along with the pauses determined and inserted by the present invention. The synthetic speech 206 is subjected to a final prosodic modification in the prosodic modification module 207. A final synthetic speech output 208 is produced containing the pauses caused to be inserted by the rare sequence detector. For example, these pauses may be inserted before and after words that are unusual or difficult to pronounce.

Table 1 shows an example of how text can be marked up by the rare sequence detector 201 according to an embodiment of the present invention.

TABLE 1

| | |
|---|---|
| Input Text | Hello, Mrs. Wisniewski |
| Normalized text | Hello P0 missus wisnefsky |
| Normalized text plus rare | Hello P0 missus P1 <rare> wisfnefsky |
| sequence detection | </rare> |

The text “Hello, Mrs. Wisniewski” is input into the TTS system. The text is normalized and a standard pause P0 is added to produce “Hello P0 missus wisnefsky”. The rare sequence detector recognized “wisnefsky” as a rare word and inserts a rare word pause P1 into the data string and marks the beginning and the end of the rare text, e.g. “<rare>” and “</rare>”. Further processing can also include further rare word pauses inserted within “wisnefsky” itself, producing an output of “wis” P2 “nef” P3 “sky”. The length and duration of the pauses can be varied depending on their location within or between words.

While the invention has been shown and described with reference to certain preferred embodiments thereof, it will be understood by those skilled in the art that various changes in form and details may be made therein without departing from the spirit and scope of the invention as defined by the appended claims.

1. A method for improving the intelligibility of speech output by a speech synthesizer, comprising the steps of:
determining if uncommon words exist in the text; and
if it is determined that an uncommon word exists in the text, pausing the output of the synthesized speech of the uncommon word to offset the uncommon word from its surrounding speech.

2. The method of claim 1, wherein the determination is made by comparing the input text to common words stored in a database and determining if a word is uncommon if the word is not in the database.

3. The method of claim 1, wherein a word is determined as uncommon if the word is capitalized.

4. The method of claim 1, wherein the determination is made by using a statistical language model.

5. The method of claim 4, wherein the statistical language model compares a calculated value with a threshold value and if the calculated value is less than the threshold value the word is determined as uncommon.

6. The method of claim 1, wherein the determination is made by using a prediction algorithm.

7. The method of claim 6, wherein the prediction algorithm compares a calculated value with a threshold value and if the calculated value is less than the threshold value the word is determined as uncommon.

8. The method of claim 1, wherein the pausing is inserted at least one of before, after and within the uncommon word.

9. A system for improving the intelligibility of speech output by a speech synthesizer, comprising:
a rare sequence detector to determining if uncommon words exist in the text, and if it is determined that an uncommon word exists in the text, pausing the output of the synthesized speech of the uncommon word to offset the uncommon word from its surrounding speech.

10. The system of claim 9, wherein the rare sequence detector determines an that a word is an uncommon word by comparing the input text to common words stored in a database and determining if a word is uncommon if the word is not in the database.

11. The system of claim 9, wherein the rare sequence detector determines that a word is an uncommon word if the word is capitalized.

12. The system of claim 9, wherein the rare sequence detector determines that a word is an uncommon word by using a statistical language model.

13. The system of claim 12, wherein the statistical language model compares a calculated value with a threshold value and if the calculated value is less than the threshold value the word is determined as uncommon.

14. The system of claim 9, wherein the rare sequence detector determines that a word is an uncommon word by using a prediction algorithm.

15. The system of claim 14, wherein the prediction algorithm compares a calculated value with a threshold value and if the calculated value is less than the threshold value the word is determined as uncommon.

16. The system of claim 9, wherein the pausing is inserted at least one of before, after and within the uncommon word.

18. A computer program device readable by a machine, tangibly embodying a program of instructions executable by the machine to perform method steps for determining if uncommon words exist in the text, and if it is determined that an uncommon word exists in the text, pausing the output of the synthesized speech of the uncommon word to offset the uncommon word from its surrounding speech.

19. The computer program device readable by a machine, tangibly embodying a program of instructions executable by the machine of claim 18, wherein a word is determined as uncommon if the word is capitalized.

20. The computer program device readable by a machine, tangibly embodying a program of instructions executable by the machine of claim 18, wherein the determination is made by using a statistical language model.

21. The computer program device readable by a machine, tangibly embodying a program of instructions executable by the machine of claim 20, wherein the statistical language model compares a calculated value with a threshold value and if the calculated value is less than the threshold value the word is determined as uncommon.

22. The computer program device readable by a machine, tangibly embodying a program of instructions executable by the machine of claim 18, wherein the determination is made by using a prediction algorithm.

23. The computer program device readable by a machine, tangibly embodying a program of instructions executable by the machine of claim 22, wherein the prediction algorithm compares a calculated value with a threshold value and if the calculated value is less than the threshold value the word is determined as uncommon.

24. The computer program device readable by a machine, tangibly embodying a program of instructions executable by the machine of claim 18, wherein the pausing is inserted at least one of before, after and within the uncommon word.
